(19) United States
(12) Patent Application Publication
(10) Pub. No.: US 2025/0375860 A1
(43) Pub. Date: Dec. 11, 2025

(54) Electronic Torque Wrench with Automatic Moment Arm Length Determination

(71) Applicant: Apex Brands, Inc., Apex, NC (US)

(72) Inventors: Cheng Yang, Shanghai (CN); Henglian Luo, Shanghai (CN); Zheng Xu, Shanghai (CN)

(21) Appl. No.: 19/107,985

(22) PCT Filed: Sep. 1, 2022
(86) PCT No.: PCT/CN2022/116483

§ 371 Date: Feb. 28, 2025

(51) Int. Cl. B25B 23/142; G01L 3/10

(52) U.S. Cl. CPC B25B 23/1425; G01L 3/108

(57) ABSTRACT

A method is provided for determining a torque value of a torque applied by an electronic torque wrench that includes a handle, a square drive and a strain gauge. The method includes measuring an angular velocity and a normal acceleration of the handle as the handle is rotated relative to the square drive, and finding a length of a moment arm from the square drive to the handle based on the angular velocity and the normal acceleration. The method includes measuring a bending moment of a rotational force at the strain gauge that is located at a known distance from the handle, the bending moment measured as the rotational force is applied at the handle that produces the torque at the square drive. And the torque value is determined based on the bending moment, the length of the moment arm and the known distance.

### TECHNOLOGICAL FIELD

The present disclosure relates generally to torque application and measurement devices and, in particular, to a torque measurement device such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque. The electronic torque wrench may also alert the operator to release the force on the wrench when the applied torque reaches the target torque.

The torque value of a torque applied by an electronic torque wrench generally depends on the length of a moment arm from the handle to the square drive of the torque wrench. The length of the moment arm is often calibrated to the torque wrench. In some cases, however, an operator uses a different wrench head with the electronic torque wrench that increases the length of the moment arm. In these cases operator input is often required to indicate the length of the wrench head to enable an accurate determination of the torque value. The manual entry of the length of the wrench is an added burden on the operator, and leads to torque values whose accuracy depends on the accuracy of the length input by the operator. It would therefore be desirable to have a system and method that addresses this issue, as well as other possible issues.

### BRIEF SUMMARY

Example implementations of the present disclosure are directed to an apparatus such as an electronic torque wrench for torque measurement with automatic determination of the length of the moment arm. The present disclosure includes, without limitation, the following example implementations.

Some example implementations provide an electronic torque wrench comprising: a wrench body; a handle and a square drive at opposing ends of the wrench body; a gyroscope and an accelerometer configured to measure respectively an angular velocity and a normal acceleration of the handle as the handle is rotated relative to the square drive; a strain gauge located at a known distance from the handle, the strain gauge configured to measure a bending moment of a rotational force at the strain gauge, the bending moment measured as the rotational force is applied at the handle that produces the torque at the square drive; and processing circuitry configured to at least: find a length of a moment arm from the square drive to the handle based on the angular velocity and the normal acceleration; and determine the torque value based on the bending moment, the length of the moment arm and the known distance.

Some example implementations provide a method of determining a torque value of a torque applied by an electronic torque wrench that includes a handle and a square drive at opposing ends of a wrench body, and that includes a strain gauge, the method comprising: measuring an angular velocity and a normal acceleration of the handle as the handle is rotated relative to the square drive; finding a length of a moment arm from the square drive to the handle based on the angular velocity and the normal acceleration; measuring a bending moment of a rotational force at the strain gauge that is located at a known distance from the handle, the bending moment measured as the rotational force is applied at the handle that produces the torque at the square drive; and determining the torque value based on the bending moment, the length of the moment arm and the known distance.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 more particularly illustrates various components of an electronics unit of the electronic torque wrench of FIG. 1, according to some example implementations;

FIG. 3 illustrates the length of the moment arm of the electronic torque wrench, according to some example implementations;

FIG. 4 illustrates the electronic torque wrench including a wrench body, and multiple wrench heads that may be removably coupleable with the wrench body, according to some example implementations;

FIG. 5 illustrates the length of the moment arm of the electronic torque wrench that may be automatically found without operator input to indicate the length of the moment arm, according to some example implementations; and

FIGS. 6A, 6B, 6C, 6D, 6E and 6F are flowcharts illustrating various steps in a method of determining a torque value of a torque applied by an electronic torque wrench, according to various example implementations, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

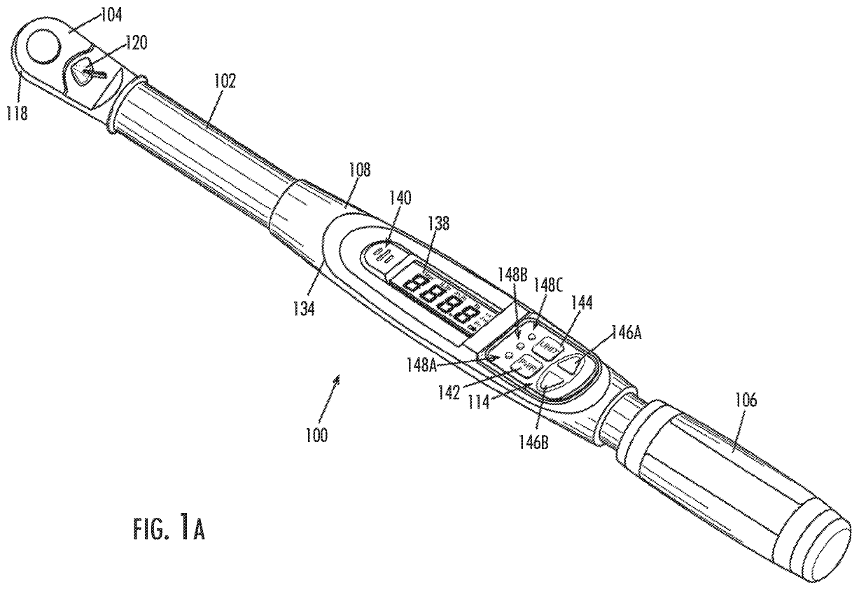

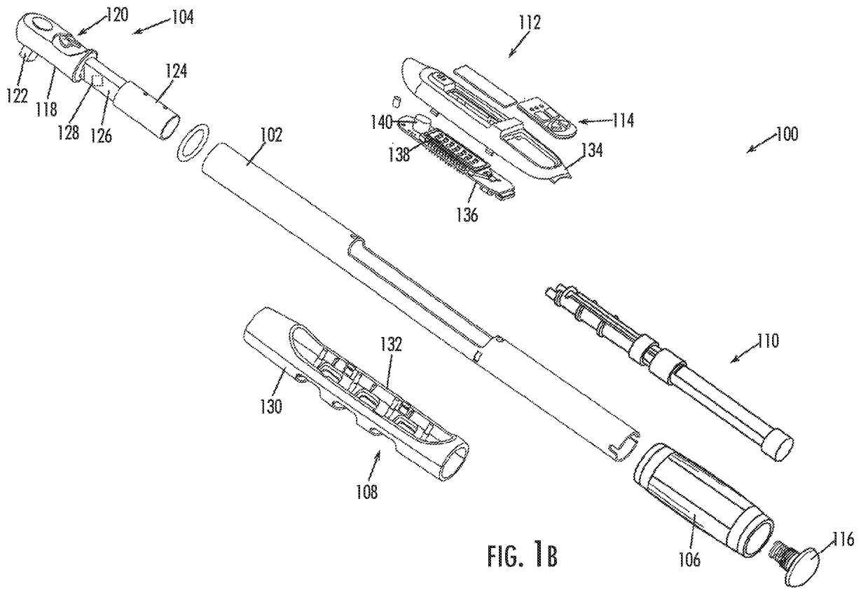

Example implementations of the present disclosure relate generally to torque application and measurement devices. Example implementations will primarily be described in the context of an electronic torque wrench. Other examples of suitable torque measurement devices include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a handle 106 (e.g., a grip handle), a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. The front end also includes a boss or square drive 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge 128. The flat portion of the wrench head is both transverse to the plane of rotation of torque wrench 100 and parallel to the longitudinal center axis of the wrench head. In some examples, the strain gauge may be embodied as an assembly of strain gauges (a strain gauge assembly). In some examples, the strain gauge is a full-bridge assembly including four separate strain gauges on a single film that is secured to the flat portion of the wrench head. Together, the full-bridge strain gauge mounted on the flat portion of the wrench head is referred to as a strain tensor.

As also shown, the housing 108 includes a bottom portion 130 that is slidably received about the wrench body 102 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

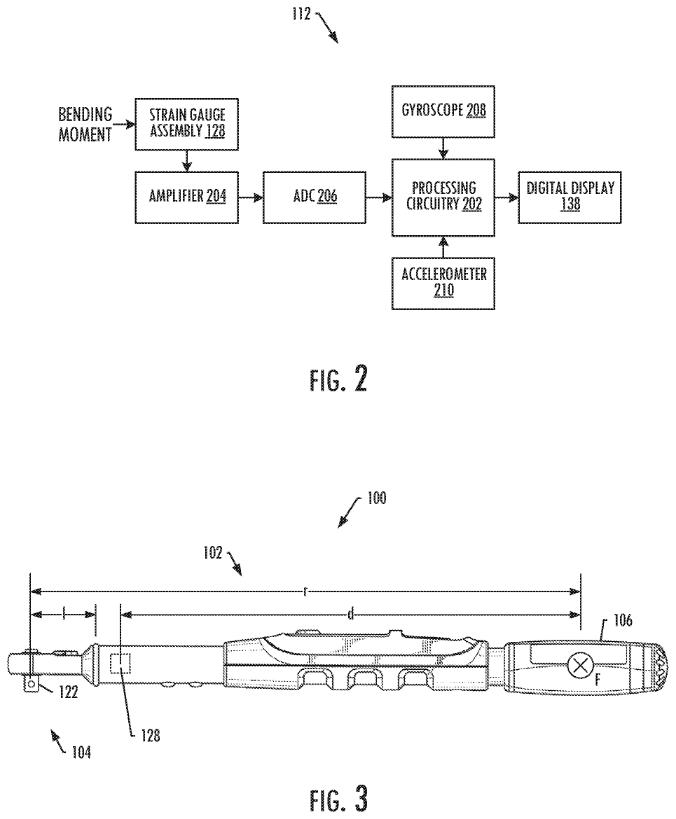

FIG. 2 more particularly illustrates various components of the electronics unit 112 of the electronic torque wrench 100, according to some example implementations. The electronics unit includes one or more of a number of components that are operably coupled to one another, as well as to other components of the electronic torque wrench. As shown, for example, the electronics unit includes one or more of processing circuitry 202, an amplifier 204, an analog-to-digital converter (ADC) 206, a gyroscope 208, an accelerometer 210, or the like.

The processing circuitry 202 may be configured to determine a torque value of a torque applied by the electronic torque wrench 100, such as a torque applied to a fastener. The processing circuitry may be configured to compare the applied torque to a target torque that may be received via the user interface 114 of the electronic torque wrench. The processing circuitry may output information to the operator such as the torque value, an alert when the applied torque is within a threshold torque of the target torque, and the like. The information may be output in a number of different manners, such as to the digital display 138 on which the information may be presented.

To determine the torque value, in some examples, the strain gauge 128 is configured to measure a bending moment of a rotational force at the strain gauge, as the rotational force is applied at the handle 106 that produces the torque at the square drive 122. In some further examples, the strain gauge is configured to produce an analog electrical signal that varies in voltage with the bending moment at the strain gauge. The amplifier 204 is configured to increase an amplitude of the analog electrical signal to produce an amplified, analog electrical signal. The ADC 206 is configured to convert the amplified, analog electrical signal to an equivalent digital electrical signal. The processing circuitry, then, is configured to determine the bending moment from the equivalent digital electrical signal, and determine the torque value based on the bending moment. In some more particular examples, the equivalent digital electrical signal includes digital data points. In some of these examples, the processing circuitry is configured to determine a subset of the digital data points in a moving sample window, and calculate the bending moment from a rolling average of the subset of the digital data points in the moving sample window.

To further illustrate use of the rolling average, consider an example in which the processing circuitry 202 samples one thousand digital data points per second and uses a moving sample window of ten milliseconds. As the rotational force is applied, the processing circuitry may average the first ten digital data points, one taken each millisecond, thereby producing a first equivalent digital value at time t=0.01 seconds, wherein t=0.0 seconds marks initiation of the rotational force. At time t=0.011 seconds, the processing circuitry may average the digital data points taken between times t=0.002 and t=0.011 seconds, thereby producing a second equivalent digital value. At time (=0.012 seconds, the processing circuitry may average the digital data points taken between times t=0.003 seconds and t=0.012 seconds, thereby producing a third equivalent digital value. And this may continue such that an equivalent digital value may be provided every millisecond until the rotational force that produces the torque is no longer applied. In short, the processing circuitry may utilize a digital filtering algorithm to provide a rolling average in which the oldest digital data point is dropped each time a new digital data point is received within the moving sample window.

As shown in FIG. 3, the torque value T of the applied torque at the square drive 122 may be generally expressed as the product of the rotational force F at the handle 106 that produced the applied torque, and the length of the moment arm r from the square drive to the handle (the handle and square drive at opposing ends of the wrench body 102). The bending moment T_{b} at the strain gauge 128 may be similarly expressed as the product of the rotational force Fat the handle 106 that produced the applied torque, and a distance d from the strain gauge to the handle. For a number of electronic torque wrenches 100, the length of the moment arm r and distance d are known, and the processing circuitry 202 may determine the torque value based on the bending moment, the length of the moment arm and the distance:

$$T = {T}_{b} \times \frac{r}{d} \qquad ( 1 )$$

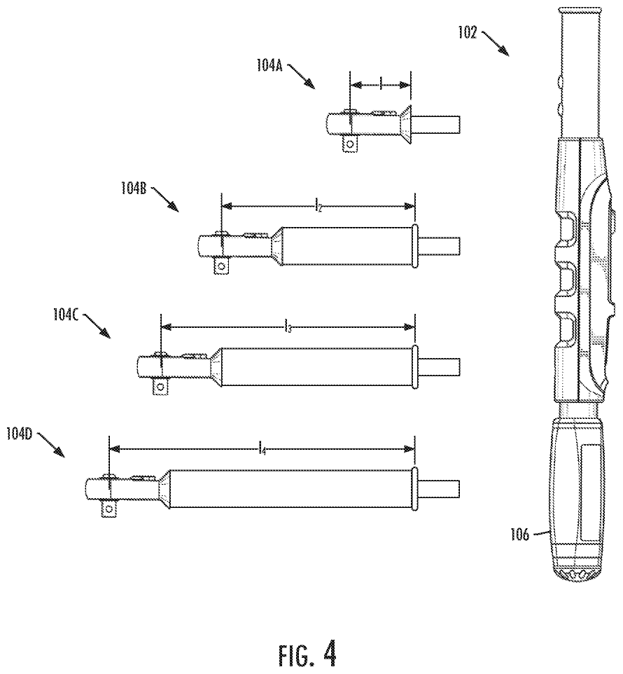

In some examples, the length of the moment arm may be variable. This may be the case for an electronic torque wrench 100 for which the wrench head 104 is any of a plurality of wrench heads that are removably coupleable with the wrench body 102. These wrench heads may have different lengths that yield different lengths of the moment arm when coupled with the wrench body. FIG. 4 illustrates a wrench body 102, and wrench heads 104A, 104B, 104C and 104D of increasing lengths 1, 12, 13, 14 that may be removably coupleable with the wrench body. A conventional electronic torque wrench has required operator input to indicate the length of the wrench head coupled with the wrench body to enable the processing circuitry 202 to accurately determine length of the moment arm, and determine the torque value from it.

According to example implementations of the present disclosure, the processing circuitry 202 may be configured to find the length of the moment arm without operator input to indicate the length of the moment arm. In various examples, the gyroscope 208 and accelerometer 210 are configured to measure respectively an angular velocity and a normal acceleration of the handle 106 as the handle is rotated relative to the square drive 122. The processing circuitry is configured to find the length of the moment arm from the square drive to the handle based on the angular velocity and the normal acceleration. And the processing circuitry is configured to determine the torque value based on the bending moment T_{b} at the strain gauge 128, the length of the moment arm r, and the known distance d from the strain gauge to the handle. In some of these examples, the length of the moment arm and the known distance are both referenced to a common point on the handle, such as a midpoint on the handle.

As shown in FIG. 5, in some more particular examples, the processing circuitry is configured to determine a rotational radius r₂ from the square drive 122 to the gyroscope 208 and the accelerometer 210 that are co-located at a second known distance d₂ from the handle 106. In this regard, the rotational radius may be determined from the angular velocity and normal acceleration at the gyroscope and the accelerometer. The angular velocity ω and normal acceleration an may be expressed in relation to velocity v as:

$$ω = \frac{v}{{r}_{2}} \qquad ( 2 )$$

$${a}_{n} = \frac{{v}^{2}}{{r}_{2}} \qquad ( 3 )$$

Equations (2) and (3) may be combined to yield an expression of rotational radius/2 as a function of the angular velocity and normal acceleration:

$${r}_{2} = \frac{{a}_{n}}{{ω}^{2}} \qquad ( 4 )$$

The rotational radius r₂ may therefore be determined based on the angular velocity and normal acceleration in accordance with equation (4).

As shown in FIG. 5, the length of the moment arm r, the known distance d from the strain gauge 128 to the handle, and the second known distance d₂ are all referenced to a common point on the handle (e.g., the midpoint on the handle). The processing circuitry is configured to then calculate the length of the moment arm from the rotational radius and the second known distance, which may be expressed as r=r₂+d₂. Substituting this expression into equation (1), then, the torque value may be determined as:

$$T = {T}_{b} \times \frac{{r}_{2} + {d}_{2}}{d} \qquad ( 5 )$$

In some examples, then, the processing circuitry 202 is further configured to derive a function that maps the bending moment T_{b} to the torque value T based on the length of the moment arm r=r₂+d₂ and the known distance d. The processing circuitry is then configured to apply the bending moment to the function. In particular, as shown in equation (5), the function in some examples includes a coefficient (r₂+d₂)/d that expresses a relationship between the length of the moment arm and the known distance; and in some of these examples, the processing circuitry is configured to multiply the bending moment T_{b} by the coefficient to determine the torque value T.

The processing circuitry 202 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

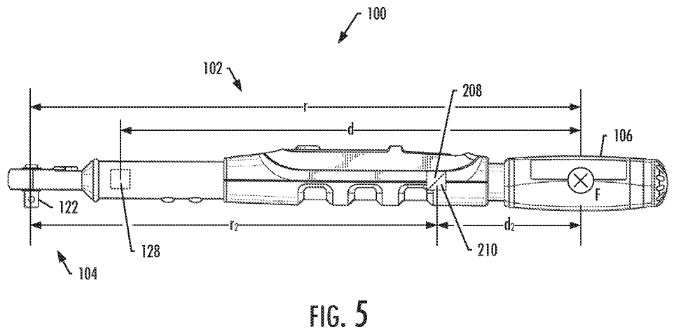

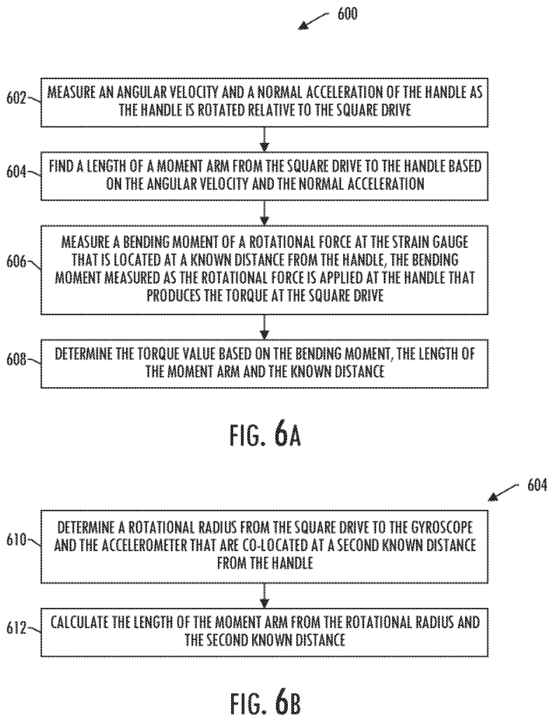

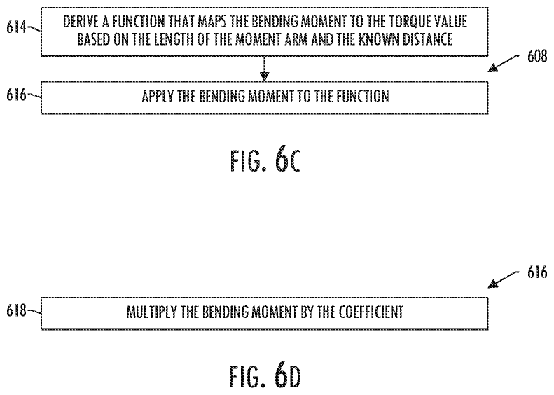

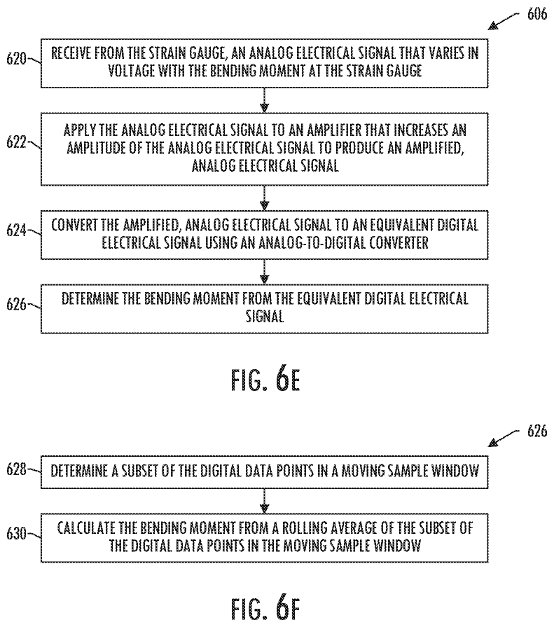

FIGS. 6A-6F are flowcharts illustrating various steps in a method 600 of determining a torque value of a torque applied by an electronic torque wrench that includes a handle and a square drive at opposing ends of a wrench body, and that includes a strain gauge, according to various example implementations. The method includes measuring an angular velocity and a normal acceleration of the handle as the handle is rotated relative to the square drive, as shown at block 602 of FIG. 6A. The method includes finding a length of a moment arm from the square drive to the handle based on the angular velocity and the normal acceleration, as shown at block 604. The method includes measuring a bending moment of a rotational force at the strain gauge that is located at a known distance from the handle, the bending moment measured as the rotational force is applied at the handle that produces the torque at the square drive, as shown at block 606. And the method includes determining the torque value based on the bending moment, the length of the moment arm and the known distance, as shown at block 608.

In some examples, the electronic torque wrench includes a wrench head with the square drive, the wrench head is any one of a plurality of wrench heads that are removably coupleable with the wrench body, and that have different lengths that yield different lengths of the moment arm when coupled with the wrench body.

In some examples, the length of the moment arm and the known distance are both referenced to a common point on the handle.

In some examples, the electronic torque wrench further includes a gyroscope and an accelerometer, and the angular velocity and the normal acceleration are measured at block 602 using respectively the gyroscope and the accelerometer.

In some examples, finding the length of the moment arm at block 604 includes determining a rotational radius from the square drive to the gyroscope and the accelerometer that are co-located at a second known distance from the handle, as shown at block 610 of FIG. 6B. And in some of these examples, finding the length of the moment arm also includes calculating the length of the moment arm from the rotational radius and the second known distance, as shown at block 612.

In some examples, the length of the moment arm, the known distance and the second known distance are all referenced to a common point on the handle.

In some examples, the method 600 further includes deriving a function that maps the bending moment to the torque value based on the length of the moment arm and the known distance, as shown at block 614 of FIG. 6C. In some of these examples, determining the torque value at block 608 includes applying the bending moment to the function, as shown at block 616.

In some examples, the function includes a coefficient that expresses a relationship between the length of the moment arm and the known distance. In some of these examples, applying the bending moment to the function at block 616 includes multiplying the bending moment by the coefficient, as shown at block 618 of FIG. 6D.

In some examples, measuring the bending moment at block 606 includes receiving from the strain gauge, an analog electrical signal that varies in voltage with the bending moment at the strain gauge, as shown at block 620 of FIG. 6E. The method 600 includes applying the analog electrical signal to an amplifier that increases an amplitude of the analog electrical signal to produce an amplified, analog electrical signal, as shown at block 622. The method includes converting the amplified, analog electrical signal to an equivalent digital electrical signal using an analog-to-digital converter, as shown at block 624. And the method includes determining the bending moment from the equivalent digital electrical signal, as shown at block 626.

In some examples, the equivalent digital electrical signal includes digital data points. In some of these examples, determining the bending moment at block 626 includes determining a subset of the digital data points in a moving sample window, as shown at block 628 of FIG. 6F. And the method includes calculating the bending moment from a rolling average of the subset of the digital data points in the moving sample window, as shown at block 630.

As explained above and reiterated below, the present disclosure includes, without limitation, the following example implementations.

Clause 1. An electronic torque wrench comprising: a wrench body; a handle and a square drive at opposing ends of the wrench body; a gyroscope and an accelerometer configured to measure respectively an angular velocity and a normal acceleration of the handle as the handle is rotated relative to the square drive; a strain gauge located at a known distance from the handle, the strain gauge configured to measure a bending moment of a rotational force at the strain gauge, the bending moment measured as the rotational force is applied at the handle that produces the torque at the square drive; and processing circuitry configured to at least: find a length of a moment arm from the square drive to the handle based on the angular velocity and the normal acceleration; and determine the torque value based on the bending moment, the length of the moment arm and the known distance.

Clause 2. The electronic torque wrench of clause 1, wherein the electronic torque wrench comprises a wrench head with the square drive, the wrench head is any one of a plurality of wrench heads that are removably coupleable with the wrench body, and that have different lengths that yield different lengths of the moment arm when coupled with the wrench body.

Clause 3. The electronic torque wrench of clause 1 or clause 2, wherein the length of the moment arm and the known distance are both referenced to a common point on the handle.

Clause 4. The electronic torque wrench of any of clauses 1 to 3, wherein the processing circuitry configured to find the length of the moment arm includes the processing circuitry configured to: determine a rotational radius from the square drive to the gyroscope and the accelerometer that are co-located at a second known distance from the handle; and calculate the length of the moment arm from the rotational radius and the second known distance.

Clause 5. The electronic torque wrench of clause 4, wherein the length of the moment arm, the known distance and the second known distance are all referenced to a common point on the handle.

Clause 6. The electronic torque wrench of any of clauses 1 to 5, wherein the processing circuitry is further configured to derive a function that maps the bending moment to the torque value based on the length of the moment arm and the known distance, and wherein the processing circuitry configured to determine the torque value includes the processing circuitry configured to apply the bending moment to the function.

Clause 7. The electronic torque wrench of clause 6, wherein the function includes a coefficient that expresses a relationship between the length of the moment arm and the known distance, and wherein the processing circuitry configured to apply the bending moment to the function includes the processing circuitry configured to multiply the bending moment by the coefficient.

Clause 8. The electronic torque wrench of any of clauses 1 to 7, wherein the strain gauge configured to measure the bending moment includes the strain gauge configured to produce an analog electrical signal that varies in voltage with the bending moment at the strain gauge, and the electronic torque wrench further comprises: an amplifier configured to increase an amplitude of the analog electrical signal to produce an amplified, analog electrical signal; an analog-to-digital converter configured to convert the amplified, analog electrical signal to an equivalent digital electrical signal, and wherein the processing circuitry is configured to determine the bending moment from the equivalent digital electrical signal.

Clause 9. The electronic torque wrench of clause 8, wherein the equivalent digital electrical signal includes digital data points, and the processing circuitry configured to determine the bending moment includes the processing circuitry configured to: determine a subset of the digital data points in a moving sample window; and calculate the bending moment from a rolling average of the subset of the digital data points in the moving sample window.

Clause 10. A method of determining a torque value of a torque applied by an electronic torque wrench that includes a handle and a square drive at opposing ends of a wrench body, and that includes a strain gauge, the method comprising: measuring an angular velocity and a normal acceleration of the handle as the handle is rotated relative to the square drive; finding a length of a moment arm from the square drive to the handle based on the angular velocity and the normal acceleration; measuring a bending moment of a rotational force at the strain gauge that is located at a known distance from the handle, the bending moment measured as the rotational force is applied at the handle that produces the torque at the square drive; and determining the torque value based on the bending moment, the length of the moment arm and the known distance.

Clause 11. The method of clause 10, wherein the electronic torque wrench includes a wrench head with the square drive, the wrench head is any one of a plurality of wrench heads that are removably coupleable with the wrench body, and that have different lengths that yield different lengths of the moment arm when coupled with the wrench body.

Clause 12. The method of clause 10 or clause 11, wherein the length of the moment arm and the known distance are both referenced to a common point on the handle.

Clause 13. The method of any of clauses 10 to 12, wherein the electronic torque wrench further includes a gyroscope and an accelerometer, and the angular velocity and the normal acceleration are measured using respectively the gyroscope and the accelerometer.

Clause 14. The method of clause 13, wherein finding the length of the moment arm includes: determining a rotational radius from the square drive to the gyroscope and the accelerometer that are co-located at a second known distance from the handle; and calculating the length of the moment arm from the rotational radius and the second known distance.

Clause 15. The method of clause 14, wherein the length of the moment arm, the known distance and the second known distance are all referenced to a common point on the handle.

Clause 16. The method of any of clauses 10 to 15, wherein the method further comprises deriving a function that maps the bending moment to the torque value based on the length of the moment arm and the known distance, and wherein determining the torque value includes applying the bending moment to the function.

Clause 17. The method of clause 16, wherein the function includes a coefficient that expresses a relationship between the length of the moment arm and the known distance, and wherein applying the bending moment to the function includes multiplying the bending moment by the coefficient.

Clause 18. The method of any of clauses 10 to 17, wherein measuring the bending moment includes: receiving from the strain gauge, an analog electrical signal that varies in voltage with the bending moment at the strain gauge; applying the analog electrical signal to an amplifier that increases an amplitude of the analog electrical signal to produce an amplified, analog electrical signal; converting the amplified, analog electrical signal to an equivalent digital electrical signal using an analog-to-digital converter; and determining the bending moment from the equivalent digital electrical signal.

Clause 19. The method of clause 18, wherein the equivalent digital electrical signal includes digital data points, and determining the bending moment includes: determining a subset of the digital data points in a moving sample window; and calculating the bending moment from a rolling average of the subset of the digital data points in the moving sample window.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An electronic torque wrench comprising:
a wrench body;
a handle and a square drive at opposing ends of the wrench body;
a gyroscope and an accelerometer configured to measure respectively an angular velocity and a normal acceleration of the handle as the handle is rotated relative to the square drive;
a strain gauge located at a known distance from the handle, the strain gauge configured to measure a bending moment of a rotational force at the strain gauge, the bending moment measured as the rotational force is applied at the handle that produces the torque at the square drive; and
processing circuitry configured to at least:
find a length of a moment arm from the square drive to the handle based on the angular velocity and the normal acceleration; and
determine the torque value based on the bending moment, the length of the moment arm and the known distance.

2. The electronic torque wrench of claim 1, wherein the electronic torque wrench comprises a wrench head with the square drive, the wrench head is any one of a plurality of wrench heads that are removably coupleable with the wrench body, and that have different lengths that yield different lengths of the moment arm when coupled with the wrench body.

3. The electronic torque wrench of claim 1, wherein the length of the moment arm and the known distance are both referenced to a common point on the handle.

4. The electronic torque wrench of claim 1, wherein the processing circuitry configured to find the length of the moment arm includes the processing circuitry configured to:
determine a rotational radius from the square drive to the gyroscope and the accelerometer that are co-located at a second known distance from the handle; and
calculate the length of the moment arm from the rotational radius and the second known distance.

5. The electronic torque wrench of claim 4, wherein the length of the moment arm, the known distance and the second known distance are all referenced to a common point on the handle.

6. The electronic torque wrench of claim 1, wherein the processing circuitry is further configured to derive a function that maps the bending moment to the torque value based on the length of the moment arm and the known distance, and
wherein the processing circuitry configured to determine the torque value includes the processing circuitry configured to apply the bending moment to the function.

7. The electronic torque wrench of claim 6, wherein the function includes a coefficient that expresses a relationship between the length of the moment arm and the known distance, and
wherein the processing circuitry configured to apply the bending moment to the function includes the processing circuitry configured to multiply the bending moment by the coefficient.

8. The electronic torque wrench of claim 1, wherein the strain gauge configured to measure the bending moment includes the strain gauge configured to produce an analog electrical signal that varies in voltage with the bending moment at the strain gauge, and the electronic torque wrench further comprises:
an amplifier configured to increase an amplitude of the analog electrical signal to produce an amplified, analog electrical signal;
an analog-to-digital converter configured to convert the amplified, analog electrical signal to an equivalent digital electrical signal, and
wherein the processing circuitry is configured to determine the bending moment from the equivalent digital electrical signal.

9. The electronic torque wrench of claim 8, wherein the equivalent digital electrical signal includes digital data points, and the processing circuitry configured to determine the bending moment includes the processing circuitry configured to:
determine a subset of the digital data points in a moving sample window; and
calculate the bending moment from a rolling average of the subset of the digital data points in the moving sample window.

10. A method of determining a torque value of a torque applied by an electronic torque wrench that includes a handle and a square drive at opposing ends of a wrench body, and that includes a strain gauge, the method comprising:
measuring an angular velocity and a normal acceleration of the handle as the handle is rotated relative to the square drive;
finding a length of a moment arm from the square drive to the handle based on the angular velocity and the normal acceleration;
measuring a bending moment of a rotational force at the strain gauge that is located at a known distance from the handle, the bending moment measured as the rotational force is applied at the handle that produces the torque at the square drive; and
determining the torque value based on the bending moment, the length of the moment arm and the known distance.

11. The method of claim 10, wherein the electronic torque wrench includes a wrench head with the square drive, the wrench head is any one of a plurality of wrench heads that are removably coupleable with the wrench body, and that have different lengths that yield different lengths of the moment arm when coupled with the wrench body.

12. The method of claim 10, wherein the length of the moment arm and the known distance are both referenced to a common point on the handle.

13. The method of claim 10, wherein the electronic torque wrench further includes a gyroscope and an accelerometer, and the angular velocity and the normal acceleration are measured using respectively the gyroscope and the accelerometer.

14. The method of claim 13, wherein finding the length of the moment arm includes:
determining a rotational radius from the square drive to the gyroscope and the accelerometer that are co-located at a second known distance from the handle; and
calculating the length of the moment arm from the rotational radius and the second known distance.

15. The method of claim 14, wherein the length of the moment arm, the known distance and the second known distance are all referenced to a common point on the handle.

16. The method of claim 10, wherein the method further comprises deriving a function that maps the bending moment to the torque value based on the length of the moment arm and the known distance, and
wherein determining the torque value includes applying the bending moment to the function.

17. The method of claim 16, wherein the function includes a coefficient that expresses a relationship between the length of the moment arm and the known distance, and
wherein applying the bending moment to the function includes multiplying the bending moment by the coefficient.

18. The method of claim 10, wherein measuring the bending moment includes:
receiving from the strain gauge, an analog electrical signal that varies in voltage with the bending moment at the strain gauge;
applying the analog electrical signal to an amplifier that increases an amplitude of the analog electrical signal to produce an amplified, analog electrical signal;
converting the amplified, analog electrical signal to an equivalent digital electrical signal using an analog-to-digital converter; and
determining the bending moment from the equivalent digital electrical signal.

19. The method of claim 18, wherein the equivalent digital electrical signal includes digital data points, and determining the bending moment includes:
determining a subset of the digital data points in a moving sample window; and
calculating the bending moment from a rolling average of the subset of the digital data points in the moving sample window.
